(19) United States
(12) Patent Application Publication
(10) Pub. No.: US 2026/0274631 A1
(43) Pub. Date: Sep. 17, 2026

(54) LIFTING APPARATUS

(71) Applicant: Gregory Freeman, Rockmart, GA (US)

(72) Inventor: Gregory Freeman, Rockmart, GA (US)

(21) Appl. No.: 19/079,030

(22) Filed: Mar. 13, 2025

(51) Int. Cl. B66F 15/00

(52) U.S. Cl. CPC B66F 15/00

(57) ABSTRACT

A lifting apparatus including a handle, a base, a vertical riser and an angle holding portion is disclosed. The handle may include a handle proximal end and a handle distal end. The base may be connected to the handle distal end. The vertical riser may be connected to a base middle portion. The vertical riser may include a vertical riser top end and a vertical riser bottom end. The angle holding portion may engage with a component of an external machine to lift the external machine. The angle holding portion may be located at the vertical riser top end. The angle holding portion may include a vertical portion and a horizontal portion. The vertical portion and the horizontal portion may form an “L-shaped” or a “V-shaped” structure.

### TECHNICAL FIELD

The present disclosure relates to a lifting apparatus, and more specifically to a lifting apparatus for lifting a mower deck of a mower.

### BACKGROUND

A lawn mower is used to mow grass or plants. The lawn mower may include a mower deck that encloses blades. The lawn mower allows an operator to set cutting height by raising or lowering the mower deck. Correct deck height ensures a clean and even cut.

To adjust the deck height, the operator is required lift the mower deck. As a conventional process of deck height adjustment, the operator manually lifts the mower deck and locks the position of the mower deck with a mower chassis, using bolts and pins. The operator may additionally lift the mower deck to perform other operations, e.g., to sharpen or replace the blades, to deck the mower deck, etc.

The mower deck is generally heavy (which may weigh over 100 lbs.), which makes it difficult for the operator to lift the deck manually. Thus, there is a need for an apparatus that assists the operator to easily lift the mower deck (or other machines).

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an isometric view of a lifting apparatus in accordance with the present disclosure.

FIG. 2 depicts an environment in which techniques and structures for providing the systems and methods disclosed herein may be implemented.

FIG. 3 depicts a side view of a lifting apparatus in accordance with the present disclosure.

FIG. 4 depicts a top view of a lifting apparatus in accordance with the present disclosure.

FIG. 5 depicts a front view of a lifting apparatus in accordance with the present disclosure.

### DETAILED DESCRIPTION

### Overview

The present disclosure is directed to a lifting apparatus that may assist an operator to easily lift heavy objects. In some aspects, the lifting apparatus may assist the operator to easily lift a mower or a mower deck, which may enable the operator to perform deck height adjustments and/or perform other operations (e.g., repair or maintenance of mower components). The lifting apparatus may act as a lever that may easily lift heavy loads (e.g., the mower deck). The operator may just need to apply a small downward force on the lifting apparatus to easily lift heavy objects.

The lifting apparatus may include a plurality of parts including, but not limited to, a handle, a base, a vertical riser and an angle holding portion. The handle may be an elongated rod having a handle proximal end and a handle distal end. The handle distal end may be connected to the base. A handle longitudinal axis may be perpendicular to a base longitudinal axis. The handle distal end may be connected to a base center/middle portion. The handle may be connected to the base to form a “T-shaped” frame. The operator may push down and position the handle (including the handle proximal end and the handle distal end) and the base on the ground during the lifting apparatus operation to cause the mower deck to move to a fully lifted position. In some aspects, the base may have a shorter length than the handle. The operator may use/hold the handle to lift or un-lift the mower deck. The base may provide stability to the lifting apparatus while the lifting apparatus is in use, and prevent toppling of the lifting apparatus.

The lifting apparatus may further include the vertical riser (or a vertical arm) that may be connected to the base center portion. The vertical riser may be a vertical rod/arm having a vertical riser top end and a vertical riser bottom end. The vertical riser bottom end may be connected to the base center portion. The vertical riser may be positioned perpendicular to both the handle and the base. For example, a handle longitudinal axis may be along a first axis (e.g., X-axis), a base longitudinal axis may be along a second axis (e.g., Y-axis), and a vertical riser longitudinal axis may be along a third axis (Z-axis), where the first, second and third axes may be perpendicular to each other. In some aspects, the vertical riser longitudinal axis may be disposed perpendicular to the ground when the lifting apparatus moves the mower deck to the fully lifted position.

The handle may act as lever and the vertical riser may act as a fulcrum, which enables the operator to easily lift the mower deck using the lifting apparatus. The lifting apparatus may have a predefined/specific ratio of the vertical riser length and the handle length. In some aspects, the predefined/specific ratio may be around 0.30 (or in a range of 0.20-0.40). This predefined ratio of 0.3 is an optimal ratio of lengths of the vertical riser and the handle, which enables the operator to lift the heavy load (e.g., the mower deck) by applying least possible downward force. At this ratio, small movements of the handle may cause smoother height adjustments of the mower deck. In addition, this predefined ratio enables the lifting apparatus to lift the mower deck above the ground while maintaining stability of the lifting apparatus during use, and prevents toppling of the lifting apparatus. The lifting apparatus may not operate in an optimal manner if the ratio described above is changed. For example, if the vertical riser is too short compared to the handle, the lifting apparatus may become top-heavy, which may cause the mower (or the mower deck) to tip or wobble when the operator is attempting to lift the mower deck by using the lifting apparatus. Similarly, if the handle is too short, the operator may need to exert more force to lift the mower deck, leading to fatigue and/or injury risk.

The lifting apparatus may further include the angle holding portion that may engage with the mower deck (or any other component of any external machine/device to be lifted using the lifting apparatus). The angle holding portion may be located at the vertical riser top end. The angle holding portion may include a vertical portion and a horizontal portion. The vertical portion and the horizontal portion may be solid rectangular plates. In some aspects, the vertical portion may be positioned perpendicular to the horizontal portion. Stated another way, an angle between the planes of the vertical portion and the horizontal portion may be 90 degrees. In further aspects, a first longitudinal edge (or a longer edge) of the vertical portion may be connected to a second longitudinal edge (or a longer edge) of the horizontal portion to form an “L-shaped” structure. In other aspects, the angle between the planes of the vertical portion and the horizontal portion may be in range of 80-90 degrees. Stated another way, in this case, the vertical portion and the horizontal portion may form a “V-shaped” structure, to hold the mower deck edge when the operator attempts to lift the mower deck by using the lifting apparatus.

The present disclosure discloses a lifting apparatus that may enable an operator to easily lift heavy objects (e.g., a mower deck). Due to its optimal structure and design, the lifting apparatus may remain stable when the mower deck is in the lifted position. In addition, due to its structure and design, the lifting apparatus may be easily stored in a small space and is easy to manufacture.

These and other advantages of the present disclosure are provided in detail herein.

### ILLUSTRATIVE EMBODIMENTS

The disclosure will be described more fully hereinafter with reference to the accompanying drawings, in which example embodiments of the disclosure are shown, and not intended to be limiting.

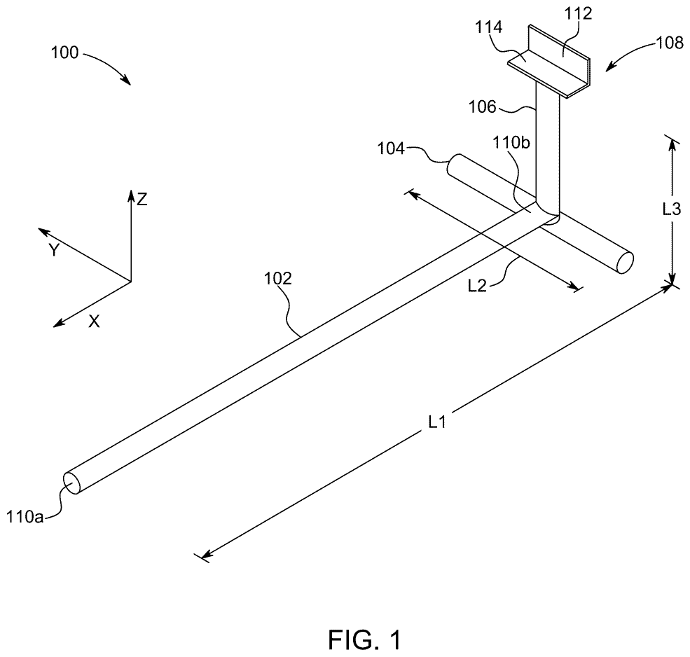

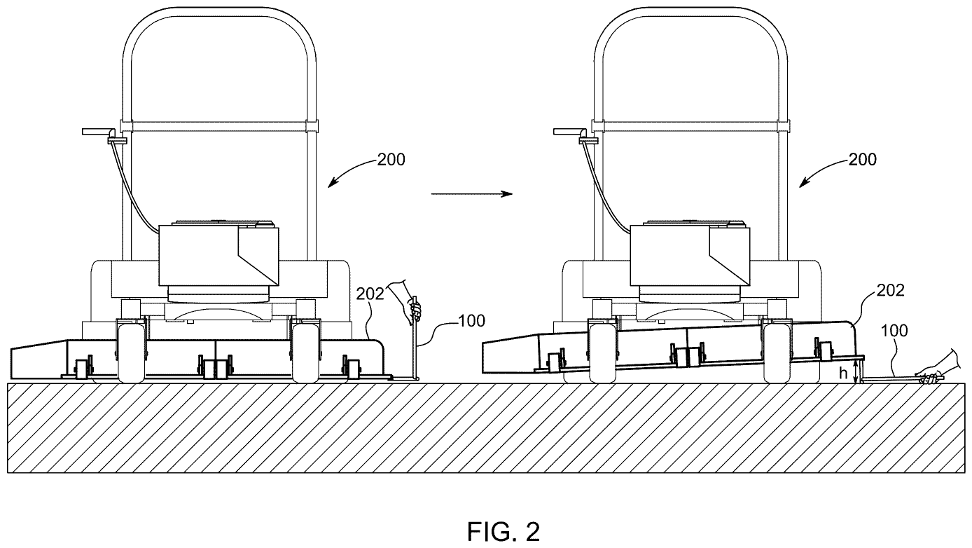

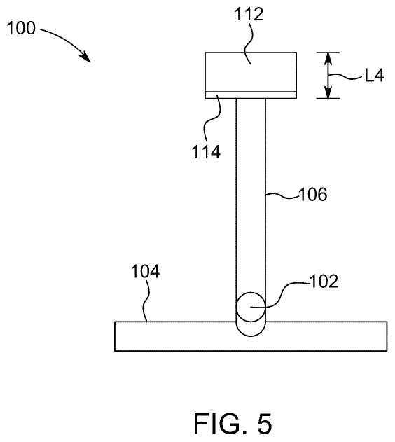

FIG. 1 depicts an isometric view of a lifting apparatus 100 in accordance with the present disclosure. FIG. 1 will be described in conjunction with FIGS. 2, 3, 4, and 5.

The lifting apparatus 100 may be used by an operator to lift an external machine or a component of an external machine. In some aspects, the external machine may be a mower 200 (shown in FIG. 2) that may be used to mow grass or plants. In some aspects, the mower 200 may be a walk-behind mower in which an operator walks behind the mower 200. In further aspects, the mower 200 may be a riding mower in which the operator may sit on the mower 200 and control it with a steering wheel or lap bars.

The exemplary aspect depicted in FIG. 2 shows the use of the lifting apparatus 100 to lift the mower 200; however, such depiction should not be construed as limiting. The operator may use the lifting apparatus 100 to lift any other machine, device or apparatus that may be heavy and require lifting, without departing from the scope of the present disclosure. The present disclosure describes an aspect where the lifting apparatus 100 lifts the mower 200, however, such description should not be construed as limiting the application of the lifting apparatus 100 only to mowers.

The mower 200 may be a conventional mower, and hence the mower's structure, components and their functions are not described in detail in the present disclosure for the sake of simplicity and conciseness.

The mower 200 may include a mower deck 202 that may be a protective housing, which holds the mower's blades, spindles and pulleys, and directs airflow for efficient cutting and clipping management. The mower deck 202 may be present beneath a mower body. In some aspects, the mower deck 202 may be positioned in a mower front portion for better visibility and easier trimming around obstacles. Alternatively, the mower deck 202 may be positioned underneath a mower center portion or at a mower rear portion. The mower 200 may include height adjustment mechanisms that may allow the operator to position the mower deck 202 at a desired height from the ground. The height adjustment mechanisms include bolts and pins that enable the operator to lock the mower deck 202 to a mower chassis at the desired height from the ground.

In some aspects, the lifting apparatus 100 may be used to lift the mower deck 202 relative to the ground, which may enable the operator to adjust height of the mower deck 202 or perform other operations (including repair/maintenance). The lifting apparatus 100 may act as a lever that may easily lift heavy loads (e.g., the mower deck 202). The operator may apply a downward force on the lifting apparatus 100 to lift the mower deck 202. The operator needs to apply a small downward force on the lifting apparatus 100 to easily lift the heavy objects (e.g., the mower deck 202).

The operator may lift the mower deck 202 by using the lifting apparatus 100, and lock the position of the mower deck 202 with the mower chassis using the bolts and pins to position the mower deck 202 at the desired height. The operator may engage the lifting apparatus 100 with an edge of the mower deck 202, to lift the mower deck 202 above the ground, as shown in FIG. 2. For example, the lifting apparatus 100 may lift the mower deck edge to a height “h” above the ground. The height “h” may be in a range of 5-6 inches. Alternatively, the height “h” may be more or less than the above-mentioned range. The structural details of the lifting apparatus 100 are provided below.

The lifting apparatus 100 may include a plurality of parts including, but not limited to, a handle 102, a base 104, a vertical riser 106 and an angle holding portion 108. The handle 102, the base 104, the vertical riser 106 and the angle holding portion 108 may be made of any material including steel and/or aluminum due to their high strength and durability, which is necessary to withstand the forces involved in lifting heavy loads.

The handle 102 may be an elongated rod (e.g., a cylindrical or a cuboidal elongated rod) having a handle proximal end 110a and a handle distal end 110b. The operator may hold the lifting apparatus 100 at the handle proximal end 110a (or at a handle middle portion), and may use the handle 102 to lift or un-lift the mower deck 202. The handle proximal end 110a may face the operator when the operator may be using the lifting apparatus 100 to lift the mower deck 202.

The handle distal end 110b may be connected to the base 104. In some aspects, the handle distal end 110b may be connected to a base middle portion (e.g., or at a base center portion). In some aspects, the handle distal end 110b may be welded to the base center portion. A handle longitudinal axis may be perpendicular to a base longitudinal axis. Stated another way, the handle 102 may be connected to the base 104 to form a “T-shaped” frame. The handle 102 (including the handle proximal end 110a and the handle distal end 110b) and the base 104 may contact or face the ground when the lifting apparatus 100 is in use and the mower deck 202 is in a fully lifted position. Stated another way, the handle 102 (including the handle proximal end 110a and the handle distal end 110b) and the base 104 may be positioned parallel to the ground when the lifting apparatus 100 is in use and the mower deck 202 is in the fully lifted position. A plane of the T-shaped frame including the handle 102 and the base 104 may be parallel to the ground surface in the configuration described above.

The base 104 may provide stability to the lifting apparatus 100 when the lifting apparatus 100 is in use, and prevent toppling or wobbling of the lifting apparatus 100 during usage. In some aspects, the base 104 may be a cylindrical rod that may be shorter in length than the handle 110. In some aspects, a handle length “L1” may be in a range of 16-20 inches. In a preferred embodiment, the handle length “L1” may be 18 inches. Further, a base length “L2” may be in a range of 5-8 inches. In a preferred embodiment, the base length “L1” may be 6 inches.

As described above, the lifting apparatus 100 may further include the vertical riser 106 (or vertical arm) that may be connected to the base center portion. In some aspects, the vertical riser 106 may be welded to the base center portion. The vertical riser 106 may be a vertical rod/arm having a vertical riser top end and a vertical riser bottom end. The vertical riser bottom end may be connected to the base center portion. The vertical riser 106 may extend from a top surface of the base center portion, and the handle 102 may extend from a front surface of the base center portion.

The vertical riser 106 may be positioned perpendicular to both the handle 102 and the base 104. For example, a handle longitudinal axis may be along a first axis (e.g., X-axis), a base longitudinal axis may along a second axis (e.g., Y-axis), and a vertical riser longitudinal axis may be along a third axis (Z-axis), where the first, second and third axes are perpendicular to each other. In some aspects, the vertical riser longitudinal axis may be perpendicular to the ground when the lifting apparatus 100 is in use and the mower deck 202 is in the fully lifted position.

The vertical riser 106 may be a cylindrical or a cuboidal rod that may raise the mower deck 202 (or any other component/machine) above the ground (e.g., at the height “h” above the ground, as shown in FIG. 2). In some aspects, a vertical riser length “L3” may be a range of 5-6 inches. In a preferred embodiment, the vertical riser length “L3” may be 5.5 inches. In some aspects, the vertical riser 106 may raise the mower deck 202 at a height of 5-6 inches (which may be equivalent to the vertical riser length “L3”). In additional aspects, the vertical riser 106 may include a telescopic mechanism (not shown) that may allow adjustment of the vertical raiser length “L3”. The operator may adjust the vertical riser length “L3” based on the mower deck height adjustment requirements.

The handle 102 may act as lever and the vertical riser 106 may act as a fulcrum, which enables the operator to easily lift the mower deck 202 using the lifting apparatus 100. The lifting apparatus 100 may have a predefined/specific ratio of the vertical riser length “L3” and the handle length “L1”. In a preferred embodiment, the predefined/specific ratio is equivalent to 0.30 (or in a range of 0.20-0.40). It has been observed by testing that this predefined ratio enables the operator to lift the heavy load (e.g., the mower deck 202) by applying least amount of downward force. At this ratio, small handle 102 movements may cause smoother height adjustments of the mower deck 202. In addition, this predefined ratio enables the lifting apparatus 100 to lift the mower deck 202 above the ground while maintaining stability of the lifting apparatus 100 during use, and prevents toppling of the lifting apparatus 100. The lifting apparatus 100 may not operate in an optimal manner if the ratio described above is changed. For example, if the vertical riser 106 is too short compared to the handle 102, the lifting apparatus 100 may become top-heavy, which may cause the mower 200 (or the mower deck 202) to tip or wobble when the operator is attempting to lift the mower deck 202 by using the lifting apparatus 100. Similarly, if the handle 102 is too short, the operator may need to exert more force to lift the mower deck 202, leading to fatigue and/or injury risk.

As described above, the lifting apparatus 100 may further include the angle holding portion 108 that may engage with the mower deck 202 (or any other component of any external machine/device to be lifted using the lifting apparatus 100). The angle holding portion 108 may be located at the vertical riser top end. In some aspects, the angle holding portion 108 may be welded at the vertical riser top end.

The angle holding portion 108 may include a vertical portion 112 and a horizontal portion 114. The vertical portion 112 and the horizontal portion 114 may be solid rectangular plates. In some aspects, the vertical portion 112 may be positioned perpendicular to the horizontal portion 114. Stated another way, an angle between the planes of the vertical portion 112 and the horizontal portion 114 may be 90 degrees.

In some aspects, the horizontal portion 114 may include a horizontal portion proximal end and a horizontal portion distal end. The vertical portion 112 may include a vertical portion top end and a vertical portion bottom end. The horizontal portion proximal end may face the operator when the operator may be holding the lifting apparatus 100 to lift the mower deck 202. The horizontal portion distal end may be connected to the vertical portion bottom end. In some aspects, the horizontal portion distal end may be welded to the vertical portion bottom end. The horizontal portion distal end may be connected to the vertical portion bottom end to form an “L-shaped” structure to hold the mower deck edge. In some aspects, a first longitudinal edge (or a longer edge) of the vertical portion 112 may be connected to a second longitudinal edge (or a longer edge) of the horizontal portion 114 to form the “L-shaped” structure.

In alternative aspects, the angle between the planes of the vertical portion 112 and the horizontal portion 114 may be in a range of 80-90 degrees. Stated another way, in this case, the vertical portion 112 and the horizontal portion 114 may form a “V-shaped” structure to hold the mower deck edge (as opposed to the “L-shaped” structure described above).

In some aspects, the horizontal portion 114 may be positioned parallel to the ground and the handle 102, when the lifting apparatus 100 is in use and the mower deck 202 is in the fully lifted position. The horizontal portion 114 may provide support to a mower deck bottom portion when the lifting apparatus 100 is supporting the mower deck 202 in the lifted position. The vertical portion 112 may be positioned perpendicular to the ground and the handle 102, when the lifting apparatus 100 is in use and the mower deck 202 is in the fully lifted position.

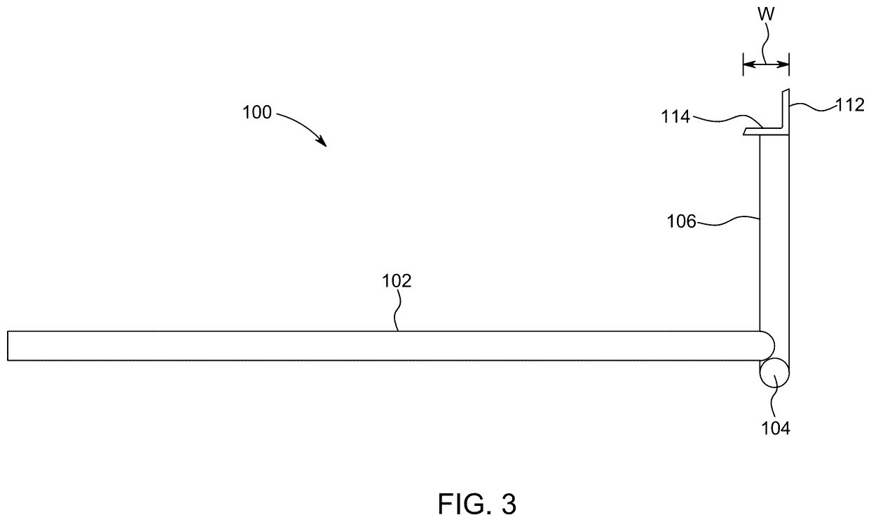

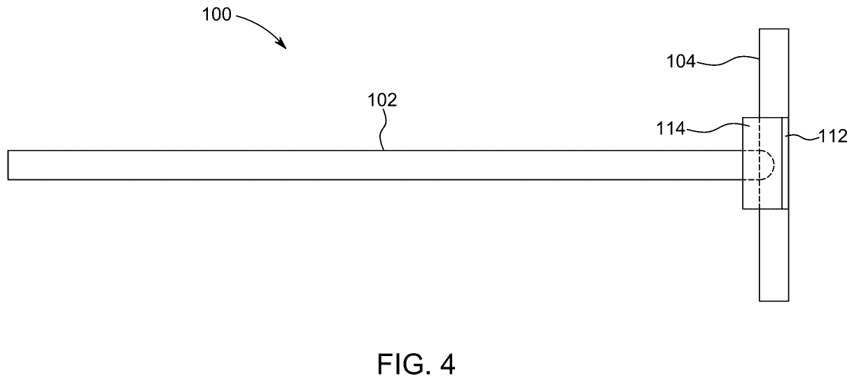

In some aspects, a width “W” (shown in FIG. 3) of the angle holding portion 108 may be around 1 inch. Further, a height “L4” (shown in FIG. 4) of the angle holding portion 108 may be up to 1 inch. For example, the height “L4” may be around 0.5 inches (or less than 0.5 inches).

In operation, the operator may hold the handle proximal end 110a and engage the angle holding portion 108 with the mower deck 202 (e.g., mower deck edge). While engaging the angle holding portion 108 with the mower deck 202, the handle longitudinal axis may be substantially perpendicular to the ground (or may be at an angle of 70-90 degrees from the ground), and may not be positioned parallel to the ground. In addition, the base 105 may rest on the ground when the operator engages the lifting apparatus 100 (e.g., the angle holding portion 108) with the mower deck 202.

After engaging the angle holding portion 108 with the mower deck 202, the operator may apply a downward force on the handle proximal end 110a towards the ground, to move the handle proximal end 110a towards the ground, such that the handle longitudinal axis may be parallel to the ground. Once the handle proximal end 110a is positioned at (or touches) the ground, the operator may leave the handle proximal end 110a. In this position, the lifting apparatus 100 may independently maintain the mower deck 202 in the fully lifted position. Once the mower deck 202 is lifted, the operator may perform height adjustment using bolt and pins as described above.

As described above, the handle 102 may act as a lever and the vertical riser 106 may act as a fulcrum, which enables the operator to easily lift the mower deck 202 using the lifting apparatus 100 (e.g., by applying a small downward force). Due to its structure and design as described above, the lifting apparatus 100 may remain stable when the mower deck 202 is in the lifted position. In addition, due to its structure and design, the lifting apparatus 100 may be easily stored in a small space and is easy to manufacture.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A lifting apparatus comprising:
a handle having a handle proximal end and a handle distal end;
a base connected to the handle distal end;
a vertical riser connected to a base middle portion, wherein the vertical riser comprises a vertical riser top end and a vertical riser bottom end; and
an angle holding portion configured to engage with a component of an external machine to lift the external machine, wherein the angle holding portion is located at the vertical riser top end,
wherein the angle holding portion comprises a vertical portion and a horizontal portion, and wherein the vertical portion and the horizontal portion form an “L-shaped” or a “V-shaped” structure.

2. The lifting apparatus of claim 1, wherein the base is connected to the handle distal end to form a T-shaped frame.

3. The lifting apparatus of claim 1, wherein a handle longitudinal axis is perpendicular to both a base longitudinal axis and a vertical riser longitudinal axis.

4. The lifting apparatus of claim 1, wherein the angle holding portion is welded to the vertical riser top end.

5. The lifting apparatus of claim 4, wherein the vertical portion and the horizontal portion are rectangular plates.

6. The lifting apparatus of claim 5, wherein an angle between the vertical portion and the horizontal portion is between 80-90 degrees.

7. The lifting apparatus of claim 1, wherein a length of the vertical riser is in a range of 5-6 inches.

8. The lifting apparatus of claim 1, wherein a length of the base is in a range of 5-8 inches.

9. The lifting apparatus of claim 1, wherein a length of the handle is in a range of 16-20 inches.

10. The lifting apparatus of claim 1, wherein a ratio of a length of the vertical riser and a length of the handle is 0.30.

11. The lifting apparatus of claim 1, wherein the vertical riser bottom end is connected to the base middle portion.

12. The lifting apparatus of claim 11, wherein the vertical riser bottom end is welded to the base middle portion.

13. The lifting apparatus of claim 1, wherein the handle is welded to the base middle portion.

14. The lifting apparatus of claim 1, wherein the external machine is a mower.

15. The lifting apparatus of claim 1, wherein the component is a mower deck.

16. A lifting apparatus comprising:
a handle having a handle proximal end and a handle distal end;
a base connected to the handle distal end;
a vertical riser connected to a base middle portion, wherein the vertical riser comprises a vertical riser top end and a vertical riser bottom end; and
an angle holding portion configured to engage with a component of an external machine to lift the external machine, wherein the angle holding portion is located at the vertical riser top end,
wherein the angle holding portion comprises a vertical portion and a horizontal portion, wherein the vertical portion and the horizontal portion form an “L-shaped” or a “V-shaped” structure,
wherein a ratio of a length of the vertical riser and a length of the handle is 0.30.

17. The lifting apparatus of claim 16, wherein the length of the vertical riser is in a range of 5-6 inches.

18. The lifting apparatus of claim 16, wherein the length of the handle is in a range of 16-20 inches.

19. The lifting apparatus of claim 16, wherein a handle longitudinal axis is perpendicular to both a base longitudinal axis and a vertical riser longitudinal axis.

20. A lifting apparatus comprising:
a handle having a handle proximal end and a handle distal end;
a base connected to the handle distal end;
a vertical riser connected to a base middle portion, wherein the vertical riser comprises a vertical riser top end and a vertical riser bottom end; and
an angle holding portion configured to engage with a component of an external machine to lift the external machine, wherein the angle holding portion is located at the vertical riser top end,
wherein the angle holding portion comprises a vertical portion and a horizontal portion, wherein the vertical portion and the horizontal portion form an “L-shaped” or a “V-shaped” structure, and
wherein the vertical portion and the horizontal portion are rectangular plates.
